(19) United States
(12) Patent Application Publication
(10) Pub. No.: US 2021/0252954 A1
(43) Pub. Date: Aug. 19, 2021

(54) GOLF CART SUNSHIELD DEVICE

(71) Applicant: Carl J. Abraham, Great Neck, NY (US)

(72) Inventor: Carl J. Abraham, Great Neck, NY (US)

(21) Appl. No.: 16/789,680

(22) Filed: Feb. 13, 2020

(51) Int. Cl. B60J 11/00

(52) U.S. Cl. CPC B60J 11/00

(57) ABSTRACT

A sunshield device for a golf cart includes at least one elongate panel formed of a polymer material and including a tinted UV absorbing film applied to at least one side of the panel. In use, the panel is adjustably fastened to forward canopy support posts of the golf cart so that the panel extends horizontally across the windshield area. In one embodiment, the panel is fastened to the support posts with hook and loop releasable fasteners and the panel is adjustably positioned according to the angle of the sun in the sky and the seated height of the occupant(s) in the golf cart to shield the occupant(s) eyes from the sun. In a preferred embodiment, two elongate panels are provided and either or both can be removed from the front support posts and releasably fastened to rear canopy support posts behind the occupant(s) for storage.

### BACKGROUND OF THE INVENTION

### Field of the Invention

The present invention relates to a sunshield device for attachment to a golf cart to shield the occupants' eyes from the sun.

### Discussion of the Related Art

Most golf carts are equipped with a hard canopy that is typically supported by a pair of forwardly positioned vertical support posts and a pair of similar rearwardly positioned vertical support posts behind the seat. A hinged windshield arrangement is mounted to the forwardly positioned vertical support posts and includes a foldable top or upper windshield section and a lower windshield section. The upper windshield section can be placed in a raised, closed position to more fully protect the occupants against inclimate conditions, such as wind and rain, and an open position, wherein the upper windshield section is hinged downwardly in overlying relation to the outside of the lower windshield section, thereby allowing air to more easily flow through the open windshield to provide greater ventilation, particularly on warm days.

Currently, no golf carts provide for protection of the driver against the glare of the sun. Thus, when the upper windshield section is in the raised, closed position or in the lowered, open position, the occupants in golf carts are still effected by sun glare, particularly when the sun is lower in the sky, such as in the morning hours or late afternoon and early evening hours. Moreover, even if the upper windshield section is tinted, there is no protection against sun glare when the upper windshield section is lowered to provide greater ventilation. On sunny days, most golfers prefer to lower the upper windshield section to allow a breeze to come through the upper windshield area, especially when the cart is moving. However, when the sun is lower in the sky and shines in the eyes of the occupants seated in the golf cart, it is extremely difficult to follow the flight of a golf ball hit by another person in their party. Presently, there is no adequate solution to protect against sun glare and ultraviolet rays through the windshield of golf carts, either when the upper windshield section is raised or lowered. Accordingly, there remains a definite need in the related art for a sunshield device that is easily fitted to all existing models of golf carts, and wherein the sunshield device can be adjustably positioned to accommodate for the angle of the sun in the sky, as well as the height of the occupants in the golf cart. Further, there is a need for a sunshield device that is easy to attach and remove from the front windshield frame structure of a golf cart, and which can further be easily stowed on the rear canopy support posts of the golf cart, behind the seated occupants riding in the golf cart. Moreover, there is a need for a sunshield device for adjustable attachment to the windshield frame structure of a golf cart, and wherein the sunshield device provides UV protection and protection against sun glare across the entire width of the windshield with no unprotected gaps.

### Objects and Advantages of the Invention

Considering the forgoing, it is a primary object of the present invention to provide a sunshield device for easy installation on existing golf carts, and wherein the sunshield device is adjustably positionable to accommodate for the angle of the sun in the sky, as well as the seated height of the driver and passenger in the golf cart.

It is a further object of the present invention to provide a sunshield device for easy installation to existing golf carts, and wherein the sunshield device is specifically structured to extend across the entire transverse width of the windshield area, and wherein the sunshield device is further adapted for adjustable positioning on the front canopy support posts on opposite sides of the windshield area.

It is still a further object of the present invention to provide a sunshield device for easy attachment and removal on existing golf carts, and wherein the sunshield device provides for UV protection.

It is still a further object of the present invention to provide a sunshield device for easy attachment and removal on existing golf carts, and wherein the sunshield device is inexpensive and lightweight.

It is yet a further object of the present invention to provide a sunshield device for easy installation and removal on the front canopy support posts of existing golf carts to provide sun glare protection to the driver and passenger in the golf cart, and further wherein the sunshield device can be removed from the windshield area and easily and conveniently stowed on a rear frame structure of the golf cart behind the seated occupants of the golf cart.

It is still a further object of the present invention to provide a sunshield device for easy installation and removal on existing golf carts, and wherein the sunshield device allows for airflow and ventilation through the front windshield area when the upper windshield panel of the golf cart is in the lowered position.

It is yet a further object of the present invention to provide a sunshield device for easy installation and removal on existing golf carts, and wherein the sunshield device can be installed and adjustably positioned at the front windshield area of the golf cart, with the upper windshield section in either the raised (i.e., closed) position or the lowered (i.e., open) position.

These and other objects and advantages of the present invention are more readily apparent with reference to the following detailed description taken in conjunction with the accompanying drawings.

### SUMMARY OF THE INVENTION

The present invention is directed to a sunshield device for a golf cart. The sunshield device includes at least one elongate panel formed of a polymer material and including a tinted UV absorbing film covering a front surface or rear surface of the elongate panel. In use, the elongate UV sunshield panel is adjustably fastened to forward canopy support posts of the golf cart so that the elongate panel extends horizontally across the entire width of the windshield area with no gaps or unshielded spaces. In one embodiment, the UV sunshield panel is fastened to the support posts with hook and loop releasable fasteners and the UN sunshield panel is adjustably positioned according to the angle of the sun in the sky and the seated height of the occupant(s) in the golf cart to shield the occupant(s) eyes from the sun. In a preferred embodiment, two elongate UV sunshield panels are provided and either or both can be removed from the front support posts and releasably fastened to rear canopy support posts behind the occupant(s) for storage.

One or both of the UV sunshield panels can be attached to the front support posts to extend across the entire transverse width of the windshield area with the upper windshield section of the golf cart in either the raised (i.e., closed) position or the lowered (i.e., open) position. Moreover, one or both of the UV sunshield panels can be selectively positioned on the front support posts at any height that is comfortable for the driver and passenger, while still allowing airflow and circulation through the upper windshield area when the upper windshield section is lowered.

### BRIEF DESCRIPTION OF THE DRAWINGS

For a fuller understanding of the nature of the present invention, reference should be made to the following detailed description taken in conjunction with the accompanying drawings in which:

FIG. 1 is a front perspective view of a pair of elongate panels of polymer material providing the sunshield device of the present invention, and wherein each of the elongate panels of polymer material are provided with a tinted UV absorbing film on either the front side or rear side, and one component of a hook and loop fastener system extending vertically, adjacent the opposite outer side edges;

FIG. 2 is a front perspective view of a golf cart shown with the sunshield device of the present invention installed to the forward vertical canopy support posts and with the upper windshield section hinged down to provide ventilation;

FIG. 3 is a side perspective view showing the sunshield device of the present invention installed on the front vertical canopy support posts of a golf cart with the upper windshield section hinged down to open the upper portion of the windshield for ventilation;

FIG. 4 is a side perspective view illustrating removable attachment of the elongate panels of the sunshield device selectively to the front vertical support posts or rear vertical support posts of the golf cart; and

FIG. 5 is an isolated perspective view, shown in partial cutaway, illustrating the releasable hook and loop fasteners of the adjustable attachment system, including a first component of a hook and loop fastener on the opposite ends of the elongate sunshield panel and a second cooperating component of a releasable hook and loop fastener on the front vertical canopy support posts and rear vertical canopy support posts of the golf cart, thereby allowing for releasable attachment and adjustable positioning of the elongate sunshield panels to either the front support posts or rear support posts of the golf cart.

Like reference numerals refer to like parts throughout the several views of the drawings.

### DETAILED DESCRIPTION OF THE PREFERRED EMBODIMENT

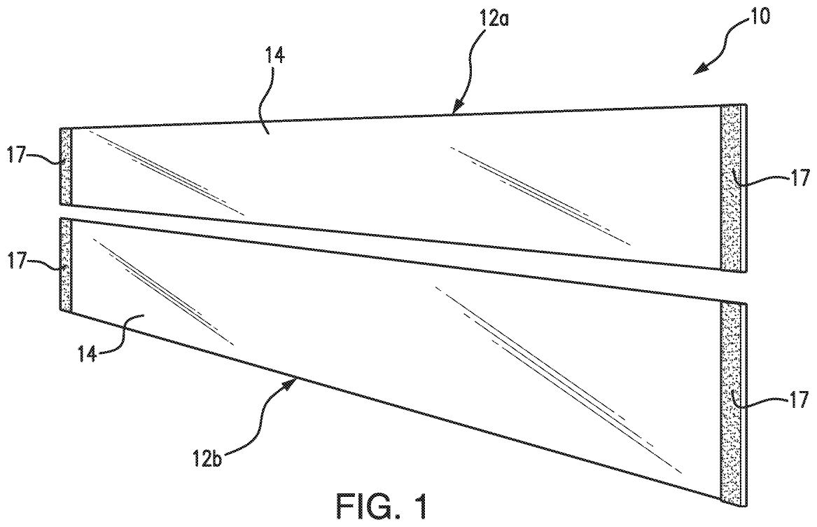

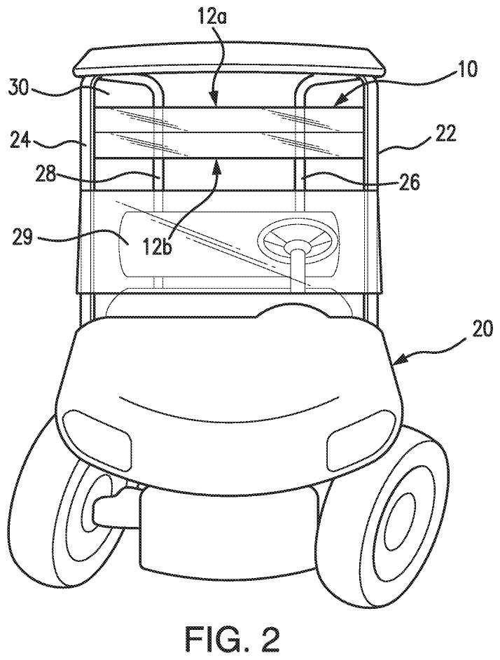

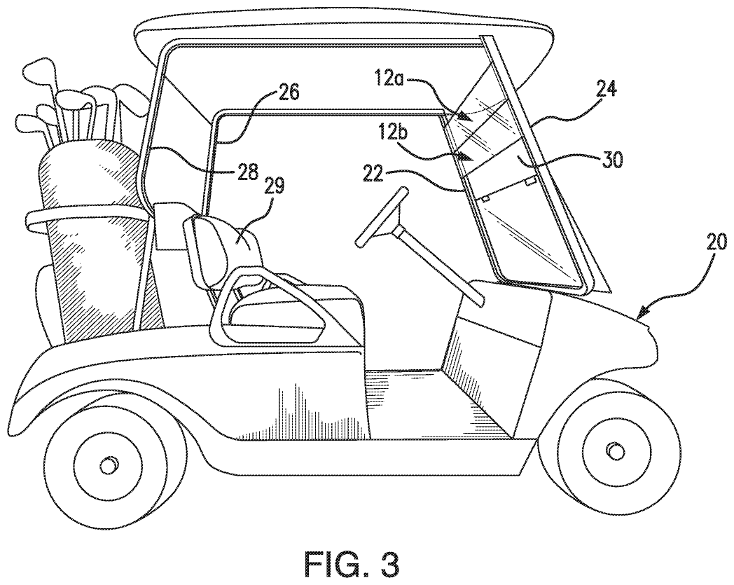

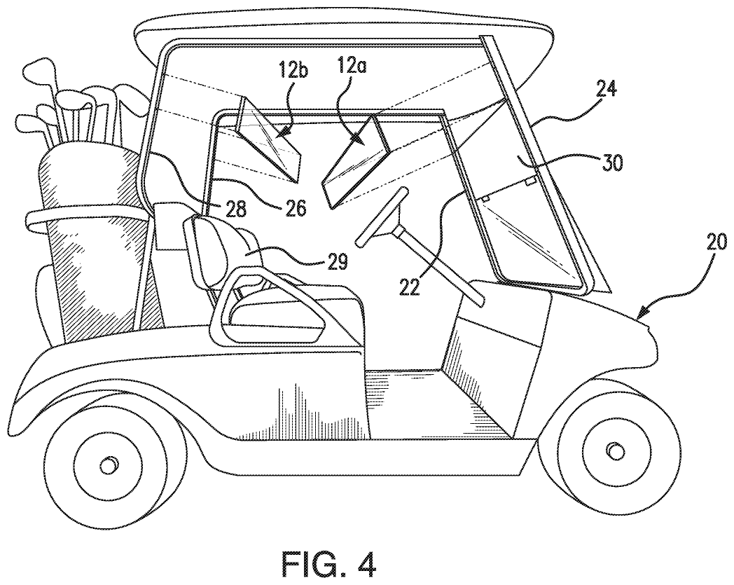

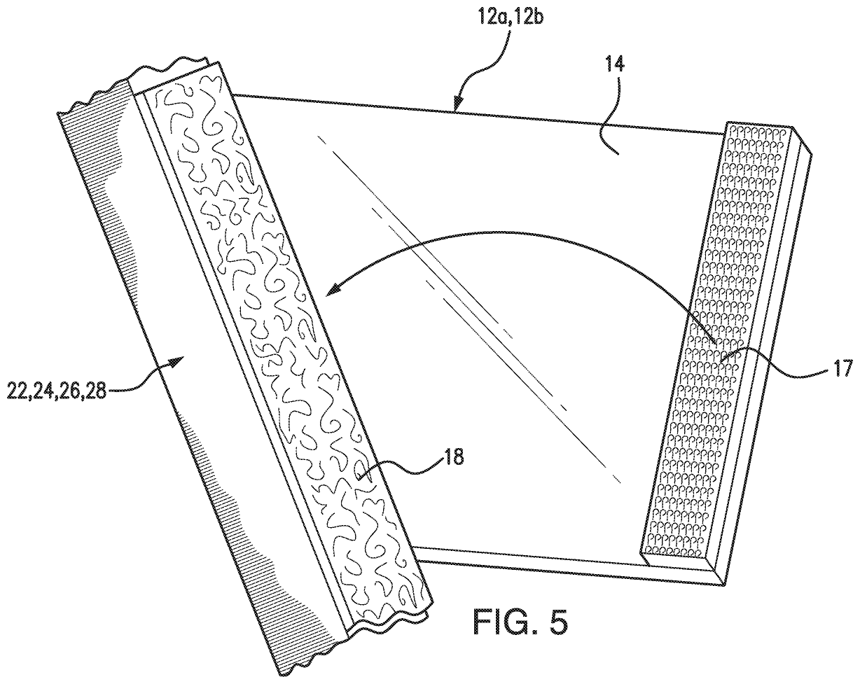

The present invention is directed to a sunshield device for golf carts and is referred to generally as 10 throughout the several views of the drawings. The sunshield device 10 includes two elongate panels 12a, 12b, formed of a polymer material and including a tinted UV absorbing film applied to and covering at least one of the front surface 14 or rear surface 16 of each of the panels. The opposite ends of the front faces of the panels 12a, 12b are provided with a first component 17 of a hook and loop releasable fastener. In use, the panels of polymer material are removably secured to the left and right front canopy support posts 22, 24 of the golf cart 20, as seen in FIGS. 2-4. Either or both of the sunshield panels 12a, 12b can be easily removed from the front canopy support posts 22, 24 for attachment to the rear canopy support posts 26, 28 behind the seat 29 of the golf cart 20, as shown in FIG. 4. Thus, on a cloudy day when the sun is not a problem for vision, the sunshield panels 12a, 12b can be removed from the front canopy support posts 22, 24 and attached to the rear canopy support posts 26, 28 for stowage. Alternatively, it may be desirous to use just one sunshield panel 12a on the front canopy support posts to provide greater airflow through the upper windshield area 30, particularly when the cart is moving. In this case, the second sunshield panel 12b can be stowed on the rear canopy support posts 26, 28 behind the occupants in the golf cart. To removably attach the sunshield panels to either the front canopy support posts 22, 24 or the rear canopy support posts 26, 28, each of the support posts are provided with a cooperating second component 18 of a releasable hook and loop fastener for releasable attachment with the mating component 17 of the releasable hook and loop fastener on the opposite ends of each of the sunshield panels, as seen in FIGS. 1 and 5. More particularly, FIG. 5 shows an isolated close-up view of the first component 17 of the hook and loop releasable fastener on the end of the sunshield panel 12a and the cooperating second component 18 of the hook and loop releasable fastener on one of the canopy support posts. Each of the canopy support posts is provided with the cooperating second component 18 of the hook and loop releasable fastener, on the surface of the post that faces towards the interior of the golf cart. As seen in FIGS. 2-4, an upper windshield section 32 of the golf cart 20 is hinged outwardly and down to a lowered position in overlying relation to a lower windshield section 34 on the outer facing side of the lower windshield section. This opens the upper windshield area 30 to allow for a breeze to come through, thereby providing for greater ventilation, particularly on warm days.

The sunshield panels 12a, 12b of the present invention can be attached to the left and right front canopy support posts 22, 24 with either the upper windshield section 32 in the raised, closed position or in the lowered, open position, as shown in FIGS. 2-4. Moreover, each of the sunshield panels 12a, 12b can be adjustably attached and positioned on the left and right front canopy support posts 22, 24 at a height that is sufficient to block the sun's rays relative to the occupants' eyes. Thus, as the sun is lower in the sky, the one or more sunshield panels can be moved lower on the front canopy support posts 22, 24 which is easily achieved with use of the hook and loop releasable fasteners. The adjustably positioning of one or both of the sunshield panels can also accommodate different seated heights of the occupants in the golf cart. For instance, taller occupants may prefer to have one or both of the sunshield panels 12a, 12b positioned higher on the front canopy support posts 22, 24, while shorter occupants may desire to move the sunshield panels 12a, 12b lower on the front canopy support posts 22, 24 for adequate visual protection from the sun's rays.

The sunshield panels 12a, 12b are formed of any of a variety of polymer materials including, but not limited to, polyurethane, polyethylene, vinyl, acrylate polymer, acrylic, polycarbonate, or poly methyl methacrylate (Plexi-Glass). The polymer sunshield panels 12a, 12b include a UV protectant tint film applied to either or both of the front and rear faces of the panels. The polymer material provides for desirable optical properties with no distortion or dispersion of light when viewing through the sunshield panels. Moreover, the polymer sunshield panels are lightweight and impact resistant.

While the present invention has been shown and described in accordance with a preferred and practical embodiment, it is recognized that departures from the instant disclosure are fully contemplated within the spirit and scope of the present invention which is not to be limited except as defined in the following claims as interpreted under the Doctrine of Equivalents.

What is claimed is:

1. A sunshield device for a golf cart that has left and right vertically extending forward canopy support posts on opposite sides of a windshield area, the sunshield device comprising:
at least one elongate panel formed of a transparent polymer material and having a front face, a rear face, and opposite ends, and the elongate panel further including a UV protective tint film applied to at least one of the front and rear faces, and the at least one elongate panel having a length measured between the opposite ends that is greater than a transverse distance between the left and right vertically extending forward canopy support posts so that the at least one elongate panel can span across the entire transverse width of the windshield area between the left and right vertically extending forward canopy support posts; and
releasable fasteners for releasably attaching and adjustably positioning the at least one elongate panel on the left and right vertically extending forward canopy support posts so that the at least one elongate panel spans across the entire transverse width of the windshield area at a selectively adjusted height.

2. The sunshield device as recited in claim 1 further comprising:
two of the elongate panels for individual selective and adjustably positionable attachment to and removal from the vertically extending canopy support posts.

3. The sunshield device as recited in claim 1 wherein the releasable fasteners are hook and loop fasteners.

4. The sunshield device as recited in claim 3 wherein the at least one elongate panel includes a first component of the hook and loop fasteners is on the front face of the at least one elongate panel at the opposite ends and a cooperating second component of the hook and loop fasteners is on the left and right canopy support posts of the golf cart.

5. The sunshield device as recited in claim 4 wherein the cooperating second component of the hook and loop fasteners is also on rear vertical structures of the golf cart for releasably attaching and stowing the at least one elongate panel thereon when not in use on the left and right forward canopy support posts.

6. The sunshield device as recited in claim 1 wherein the at least one elongate panel is formed of one or more transparent polymer materials that allow for unobstructed viewing through the at least one elongate panel with no distortion or dispersion of light.

7. The sunshield device as recited in claim 6 wherein the one or more transparent polymer materials are impact resistant.

8. The sunshield device as recited in claim 1 wherein the releasable fasteners allow for selective attachment and adjustable positioning of the at least one elongate panel on the left and front vertically extending forward canopy support posts with an upper windshield section of the golf cart in either a raised, closed position or a lowered, open position.
